(19) United States
(12) Patent Application Publication
(10) Pub. No.: US 2015/0178589 A1
(43) Pub. Date: Jun. 25, 2015

(54) APPARATUS FOR PROCESSING DIGITAL IMAGE AND METHOD OF CONTROLLING THE SAME

(71) Applicant: SAMSUNG ELECTRO-MECHANICS CO., LTD., Suwon-Si (KR)

(72) Inventors: Sung Woo PARK, Suwon-Si (KR); Hong Sik YANG, Suwon-Si (KR)

(73) Assignee: SAMSUNG ELECTRO-MECHANICS CO., LTD., Suwon-Si, Gyeonggi-Do (KR)

(21) Appl. No.: 14/218,415

(22) Filed: Mar. 18, 2014

(30) Foreign Application Priority Data
Dec. 20, 2013 (KR) 10-2013-0160066

(51) Int. Cl. G06K 9/52; G06F 3/01; H04N 5/232

(52) U.S. Cl. CPC G06K 9/52; H04N 5/23203; G06F 3/013

(57) ABSTRACT

There is provided an apparatus for processing a digital image, including: an image input unit providing an input image as image data; a pupil image determining unit detecting a plurality of pupil information items from the image data to determine the number of eyes in the input image from the plurality of pupil information items; a sight-line direction calculating unit determining a plurality of sight-line direction information items respectively corresponding to the respective plurality of pupil information items; an image recapturing determining unit determining whether recapturing an image is necessary based on the number of eyes and the plurality of sight-line direction information items; and an image output unit outputting the image data.

### CROSS-REFERENCE TO RELATED APPLICATION

This application claims the benefit of Korean Patent Application No. 10-2013-0160066 filed on Dec. 20, 2013, with the Korean Intellectual Property Office, the disclosure of which is incorporated herein by reference.

### BACKGROUND

The present disclosure relates to an apparatus for processing a digital image and a method of controlling the same.

Generally, apparatuses for processing digital images include all apparatuses able to process images or use motion recognition sensors, such as personal digital assistants (PDA), cell phone cameras, and PC cameras. Such apparatuses for processing digital images may receive an image from an imaging device, display the input image on a display device, store the image as an image file upon a user's selection, and print the stored image file.

When taking a group picture, in order to obtain a satisfactory image, a user may capture several images to later synthesize these images as he or she wishes to, using an apparatus for processing a digital image, or may capture images repeatedly until a satisfactory group picture is obtained.

However, it may be troublesome to move images to a device having an image synthesizing program installed therein, and capturing images repeatedly is inefficient.

Patent Document 1 below discloses an apparatus and a method for generating an image including a plurality of persons. However, Patent Document 1 fails to disclose the features of determining the number of persons in a group picture, and detecting pupil information from a captured image to calculate the number of eyes and sight-line directions within the captured image, thereby determining whether recapturing the image is necessary, as will be discussed in the present disclosure. In particular, the feature of determining sight-line directions using a plurality of light sources is not specifically disclosed in Patent Document 1.

### SUMMARY

An aspect of the present disclosure may provide an apparatus for processing a digital image and a method of controlling the same, in which an input image is provided as image data, the number of eyes and a plurality of sight-line direction information items are detected from the image data using pupil information, and it is determined whether recapturing an image is necessary.

An aspect of the present disclosure may also provide an apparatus for processing a digital image and a method of controlling the same, in which a plurality of sight-line direction information items may be determined using patterns of reflected light generated using a plurality of light sources for respective pupil information items.

According to an aspect of the present disclosure, an apparatus for processing a digital image may include: an image input unit providing an input image as image data; a pupil image determining unit detecting a plurality of pupil information items from the image data to determine the number of eyes in the input image from the plurality of pupil information items; a sight-line direction calculating unit determining a plurality of sight-line direction information items respectively corresponding to the respective plurality of pupil information items; an image recapturing determining unit determining whether recapturing an image is necessary, based on the number of eyes and the plurality of sight-line direction information items in the input image; and an image output unit outputting the image data.

The apparatus may further include a memory unit storing the image data.

The pupil image determining unit may include: a pupil information detecting unit detecting the plurality of pupil information items from the image data; an eye number determining unit determining the number of eyes from the plurality of pupil information items; a user input unit receiving information regarding the number of persons in a group picture from a user; and a pupil image control unit controlling the pupil information detecting unit so that the plurality of pupil information items is redetected from the image data if the number of detected eyes is not 2N, where N is a natural number equal to or greater than one, and controlling the user input unit so that the number of persons in the group picture is reinput by the user if the number of eyes does not match the number of persons in the group picture.

The apparatus may further include a plurality of light-emitting units providing a plurality of light sources having a predetermined luminance.

The sight-line direction calculating unit may determine the plurality of sight-line direction information items using patterns of reflected light generated by the plurality of light sources provided from the plurality of light-emitting units for respective pupil information items among the plurality of pupil information items.

The sight-line direction calculating unit may compare the plurality of sight-line direction information items with predetermined sight-line direction information to thereby determine whether a degree of matching of sight-line directions is above a predetermined threshold value.

The apparatus may further include a closed-eye determining unit determining whether an eye is closed in the input image, using the plurality of pupil information items.

According to another aspect of the present disclosure, a method of controlling an apparatus for processing a digital image may include: providing an input image as image data, using one or more processors; detecting a plurality of pupil information items from the image data to determine the number of eyes in the input image from the plurality of pupil information items; determining a plurality of sight-line direction information items respectively corresponding to the respective plurality of pupil information items; and determining whether recapturing an image is necessary based on the number of eyes and the plurality of sight-line direction information items, thereby retaking the image or outputting the image data.

The method may further include storing the image data.

The determining of the number of eyes may include: receiving information regarding the number of persons in the group picture from a user detecting the plurality of pupil information items from the image data; determining the number of eyes from the plurality of pupil information items; and determining whether the number of eyes is 2N or determining whether the number of eyes matches the number of persons in the group picture, where N is a natural number equal to or greater than one; and detecting again the plurality of pupil information items from the image data if the number of detected eyes is not 2N, and rereceiving information regarding the number of persons in the group picture from the user if the number of eyes does not match the number of persons in the group picture.

The determining of the plurality of sight-line direction information items may include: providing a plurality of light sources to the outside having a predetermined luminance; obtaining patterns of reflected light generated by the plurality of light sources for respective pupil information items among the plurality of pupil information items; and determining sight-line direction information items according to the patterns of reflected light.

The determining whether recapturing an image is necessary may include: comparing the plurality of sight-line direction information items with predetermined sight-line direction information to determine a degree of matching of sight-line directions; and determining whether the degree of matching of sight line-directions is above a predetermined threshold value.

The method may further include determining whether an eye is closed in the input image, using the plurality of pupil information items.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of an apparatus for processing a digital image according to an exemplary embodiment of the present disclosure;

FIG. 2 is a block diagram showing the pupil image determining unit in the apparatus for processing a digital image shown in FIG. 1 in detail;

FIG. 3 is a block diagram showing the apparatus for processing a digital image shown in FIG. 1 in detail;

FIG. 4 is a flow chart illustrating a method of controlling an apparatus for processing a digital image according to an exemplary embodiment of the present disclosure;

FIG. 5 is a flow chart illustrating the detecting of the plurality of pupil information items to determine the number of eyes in the input image in the method illustrated in FIG. 4 in detail;

FIG. 6 is a flow chart illustrating the determining the plurality of sight-line direction information items of the method illustrated in FIG. 4 in detail; and

FIG. 7 is a flow chart illustrating the determining whether recapturing an image is necessary of the method illustrated in FIG. 4 in detail.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

FIG. 1 is a block diagram of an apparatus for processing a digital image according to an exemplary embodiment of the present disclosure.

Referring to FIG. 1, the apparatus for processing a digital image according to the exemplary embodiment may include an image input unit 100, an image processing unit 200, an image output unit 300, and a memory unit 400.

The image input unit 100 may provide an input image as image data. The image input unit 100 may be a camera module, for example, and may output an image input from the camera module as image data to provide it to the image processing unit 200.

The image processing unit 200 may detect a number of pupil information items from the image data and may determine the number of eyes in the input image, based on the pupil information items. The image processing unit 200 may be a processor, for example. In addition, the image processing unit 200 may determine a plurality of sight-line information items respectively corresponding to the respective pupil information items. Then, it may be determined whether it is necessary to take a picture again based on the number of detected eyes and sight-line information items. If it is not necessary to take a picture again, the image data may be provided to the image output unit 300.

The image output unit 300 may output the image data from the image processing unit 200 to the outside. The image output unit 300 may be, for example, a display device.

The memory unit 400 may store final image data before the image output unit 300 outputs image data finally. In addition, the memory unit 400 may store the image data from the image input unit 100.

Specifically, the image processing unit 200 may include a pupil image determining unit 210, a sight-line direction calculating unit 220, and an image recapturing determining unit 230.

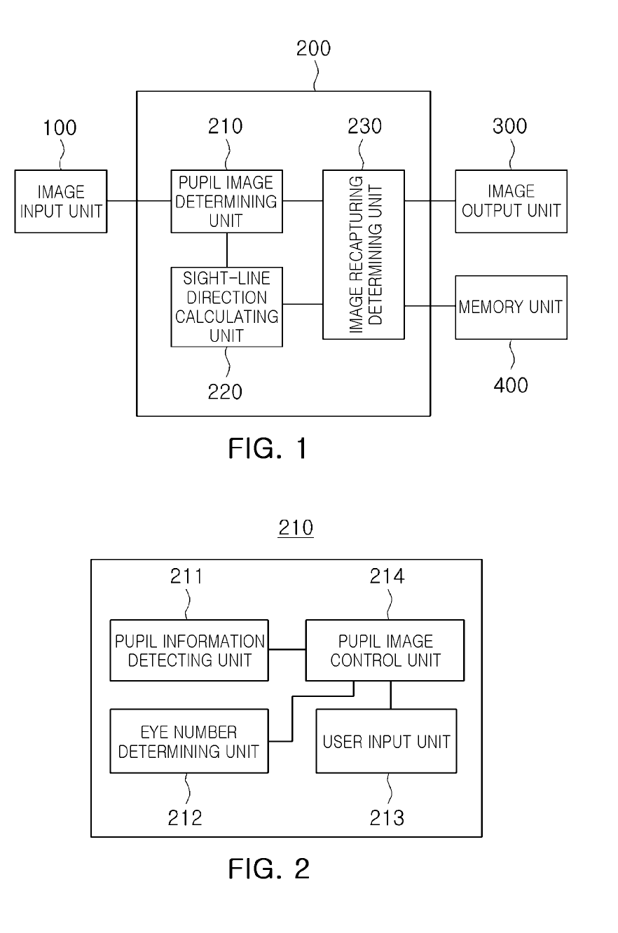

The pupil image determining unit 210 may detect a plurality of pupil information items from the image data received from the image input unit 100 so as to determine the number of eyes in the input image, based on the plurality of pupil information items. This will be described with reference to FIG. 2.

FIG. 2 is a block diagram showing the pupil image determining unit 210 in the apparatus for processing a digital image shown in FIG. 1 in detail.

The pupil image determining unit 210 may include: a pupil information detecting unit 211 detecting the plurality of pupil information items from the image data; an eye number determining unit 212 determining the number of eyes from the plurality of pupil information items; and a pupil image control unit 214 controlling the pupil information detecting unit so that the number of persons in the group picture is reinput by the user if the number of detected eyes is not 2N, where N is a natural number equal to or greater than one, and controlling the user input unit so that the plurality of pupil information items is redetected from the image data if the number of eyes does not match the number of persons in the group picture.

That is, the image data from the image input unit 100 may be provided to the pupil information detecting unit 211 in the pupil image determining unit 210. At first, the pupil information detecting unit 211 may detect a plurality of pupil information items. In order to detect the plurality of pupil information items, a face region is initially detected from the input image data, center of the face is found from the extracted face region, and then the location of the face is determined. Techniques to detect pupils are well known in the art, and therefore will not be described herein.

Further, the eye number determining unit 212 may detect the number of eyes based on the plurality of pupil information items from the pupil information detecting unit 211. In order to detect the number of eyes, location information may be used that relates to several characteristic parts of an eye located at specific positions. Based on the location information, the number of eyes may be determined based on the plurality of pupil information items.

In addition, the apparatus for processing a digital image according to the exemplary embodiment may further include a closed-eye determining unit determining whether an eye is closed in the input image, based on the plurality of pupil information items. The closed-eye determining unit may determine whether an eye is closed in the input image, by comparing contrast ratio at the pupil or by measuring the ratio of the black pupil to the white pupil.

The user input unit 213 may receive the number of persons in the group picture from a user. The user may use the apparatus for processing a digital image according to the present disclosure.

That is, the user may input the number of persons in the group picture through the user input unit 213 and may provide the number of persons in the group picture to the pupil image control unit 214.

The pupil image control unit 214 may determine if the number of eyes detected from the eye number determining unit 212 is 2N. Where N may be a natural number equal to or greater than 1.

If the number of eyes is not 2N, the pupil image control unit may control the pupil information detecting unit 211 so that it detects again a plurality of pupil information items from the image data.

Alternatively, if the number of eyes does not match with the number of persons in the group picture, the pupil image control unit 214 may control the user input unit 213 so that the user inputs again the number of persons in the group picture.

In addition to or alternatively, the pupil image control unit 214 may control the user input unit 213 so that the user inputs again the number of persons in the group picture even if the number of eyes is not 2N, and may control the pupil information detecting unit 211 so that the plurality of pupil information items is redetected from the image data even if the number of eyes does not match with the number of persons in the group picture.

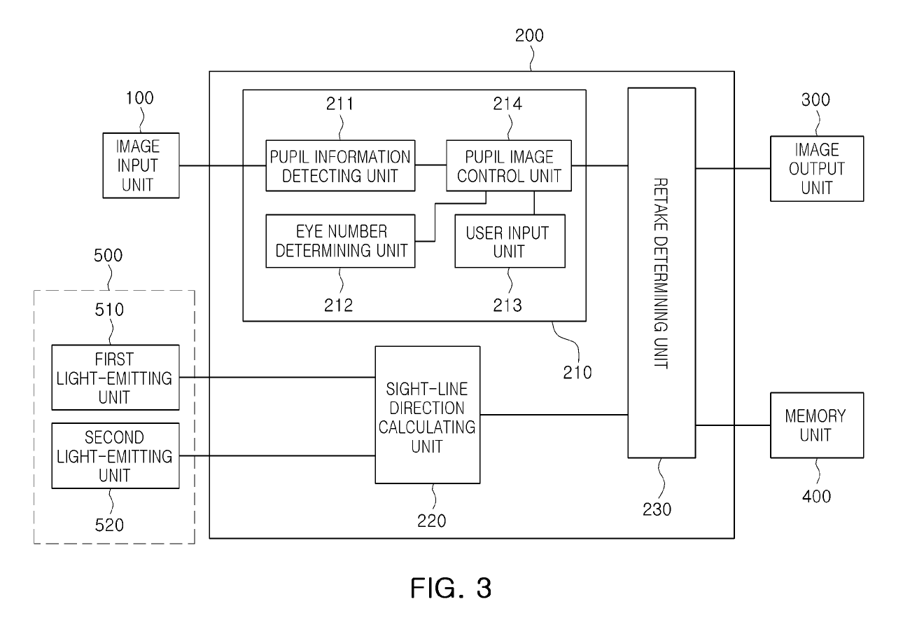

FIG. 3 is a block diagram showing the apparatus for processing a digital image shown in FIG. 1 in detail.

Referring to FIG. 3, the sight-line direction calculating unit 220 and the retake determining unit 230 may be described in detail.

As shown in FIG. 3, the apparatus for processing a digital image may further include a plurality of light-emitting units 500. Although there are two light-emitting units 500, i.e., first and second light-emitting units 510 and 520 in the example shown in FIG. 3, it is merely illustrative.

The first and second light-emitting units 510 and 520 may provide a plurality of light sources that emit light to the outside having a predetermined luminance. The first and second light-emitting units 510 and 520 may be disposed spaced apart from the image input unit 100.

Generally, a human eye is a sphere having the diameter of approximately 24 mm, and the distance between two eyes is approximately 35 mm. Based on this, the first and second light-emitting units 510 and 520 may provide light sources to a subject person. At this time, the sight-line direction calculating unit 220 may specify two or more patterns of light sources reflected on the eyes of the subject person according to the reflection law of a sphere so as to find the location of the eyes, and then may calculate the sight-lines from the eyes using the reflected light or the center of the irises.

In this manner, the sight-line direction calculating unit 220 may detect a plurality of sight-line direction information items corresponding to the plurality of pupil information.

Then, the sight-line direction calculating unit 220 may compare the plurality of sight-line direction information items with predetermined sight-line direction information, to determine the degree of matching of sight-line directions. That is, data that specifies two or more patterns of light sources reflected on eyes may have been stored in the memory unit 400 in advance, such that the stored data is compared with the sight-line direction information to thereby determine whether the degree of matching of the sight-line directions is above a predetermined threshold value. In addition, the sight-line direction calculating unit 220 may provide the calculated result to the retake determining unit 230.

The retake determining unit 230 may determine whether recapturing an image is necessary based on the number of eyes from the pupil image determining unit 210 and the degree of matching of sight-line directions from the sight-line direction calculating unit 220.

If it is determined that recapturing an image is necessary, current image data may be stored in the memory unit 400, and new image data may be provided from the image input unit 100. On the other hand, if it is determined that recapturing an image is not necessary, the retake determining unit 230 may send final image data to the memory unit 300 to store it and may send the final image data to the image output unit 300 so that it is displayed on a screen which is seen from the outside.

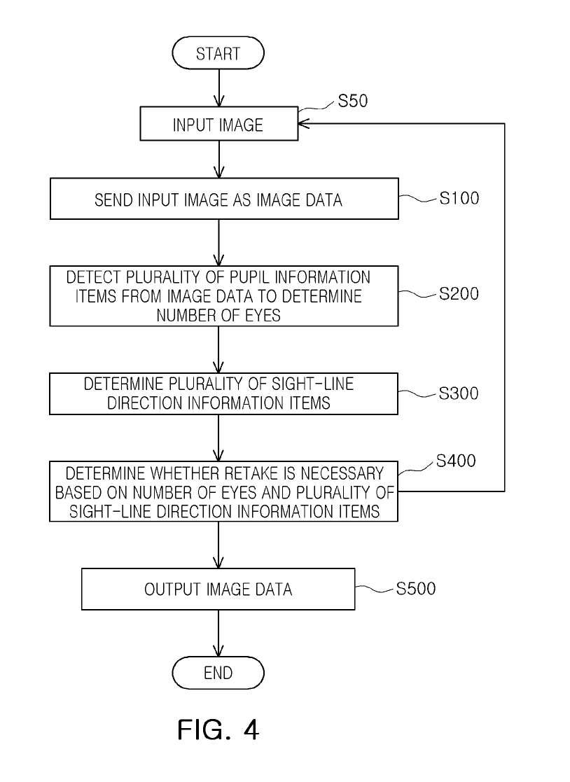

FIG. 4 is a flow chart illustrating a method of controlling an apparatus for processing a digital image according to an exemplary embodiment of the present disclosure.

Referring to FIG. 4, a method of controlling an apparatus for processing a digital image may include: capturing an image to input it (S50); providing the input image as image data (S100); detecting a plurality of pupil information items from the image data to determine the number of eyes in the input image from the plurality of pupil information items (S200); determining a plurality of sight-line direction information items respectively corresponding to the respective plurality of pupil information items (S300); determining whether recapturing an image is necessary based on the number of eyes and the plurality of sight-line direction information items (S400); and outputting the image data if no retake is necessary (S500).

The method according to the exemplary embodiment may further include storing final image data prior to outputting the final image data.

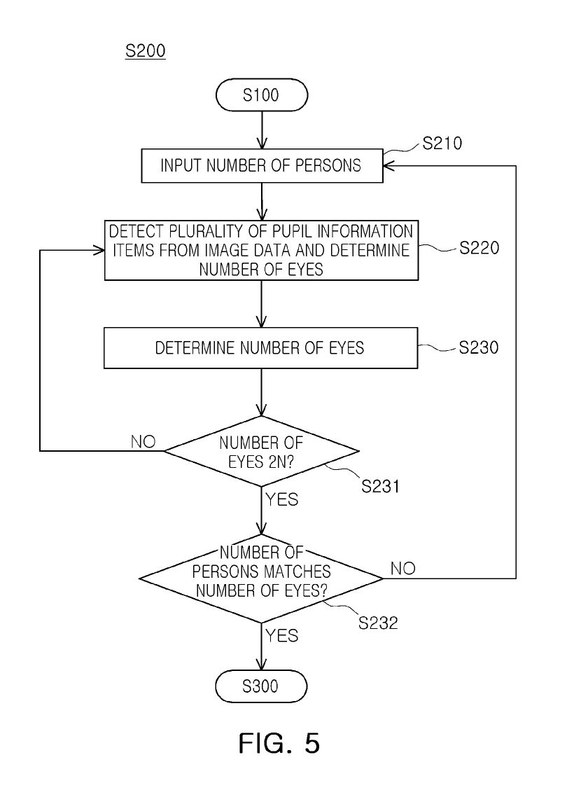

FIG. 5 is a flow chart illustrating in detail the detecting of the plurality of pupil information items to determine the number of eyes in the input image S200 in the method illustrated in FIG. 4.

Referring to FIG. 5, the detecting the plurality of pupil information items to determine the number of eyes in the input image S200 may include receiving information regarding the number of persons in the group picture from a user (S210), detecting the plurality of pupil information items from the image data (S220), determining the number of eyes based on the plurality of pupil information items (S230), determining whether the number of eyes is 2N, where N is a natural number equal to or higher than 1 (S231), and determining whether the number of persons in the group picture matches the number of eyes (S232).

As described above, if it is determined that the number of eyes is not 2N in the determining S231, where N is a natural number equal to or higher than 1, the plurality of pupil information items may be redetected from the image data, or, alternatively, the number of persons in the group picture may be input again by a user, although not illustrated in the flow chart. If it is determined that the number of persons in the group picture does not match with the number of eyes in the determining S232, the number of persons in the group picture may be input again by a user or the plurality of pupil information items may be detected from the image data.

In addition, the method of controlling the apparatus for processing a digital image according to the exemplary embodiment may further include determining whether an eye is closed in the input image, based on the plurality of pupil information items.

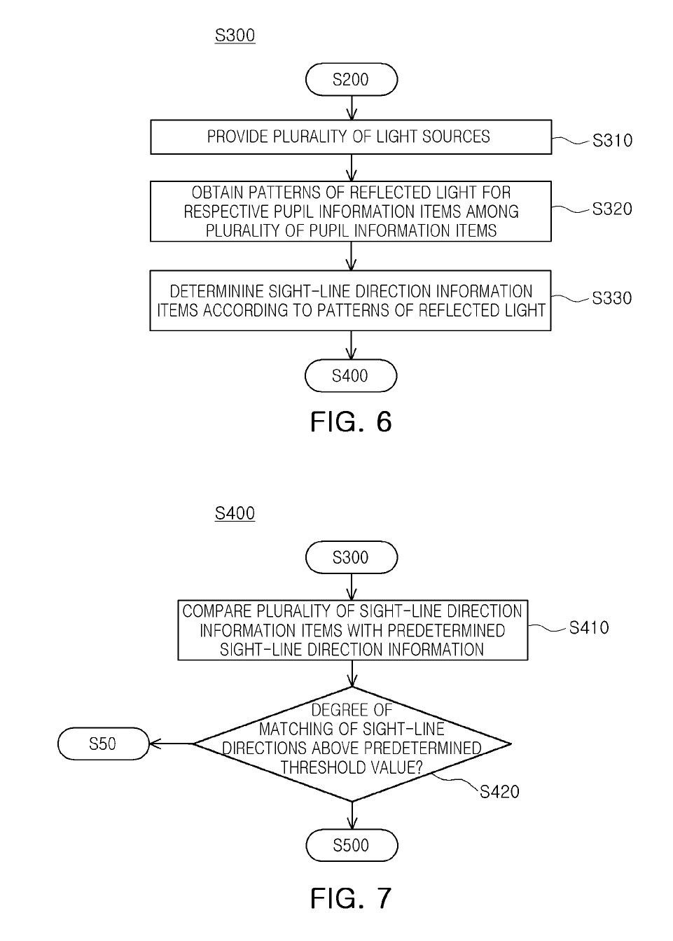

FIG. 6 is a flow chart illustrating in detail the determining of the plurality of sight-line direction information items S300 of the method illustrated in FIG. 4.

Referring to FIG. 6, the determining of the plurality of sight-line direction information items S300 may include providing a plurality of light sources to the outside having a predetermined luminance (S310), obtaining patterns of reflected light generated by the plurality of light sources for respective pupil information items among the plurality of pupil information items (S320), and determining sight-line direction information items according to the patterns of reflected light (S330). Detailed descriptions of respective operations have been already made, and thus will not be repeated.

FIG. 7 is a flow chart illustrating in detail the determining whether recapturing an image is necessary S400 of the method illustrated in FIG. 4.

The determining whether recapturing an image is necessary S400 may include comparing the plurality of sight-line direction information items with predetermined sight-line direction information to determine the degree of matching of sight-line directions (S410), and determining whether the degree of matching of sight-line directions is above a predetermined threshold value (S420). If it is determined that the degree of matching of sight-line directions is below the predetermined threshold value, a user may select retaking.

As set forth above, according to exemplary embodiments of the present disclosure, when a user takes a group picture, the user need not pay attention to whether a person in the group looks at the other way or to whether someone closed his eyes, and thus the user can take the group picture more conveniently and can save time. In addition, by calculating a plurality of sight-line directions using a plurality of light sources, sight-line directions of persons in the group picture can be determined more accurately.

While exemplary embodiments have been shown and described above, it will be apparent to those skilled in the art that modifications and variations could be made without departing from the spirit and scope of the present disclosure as defined by the appended claims.

What is claimed is:

1. An apparatus for processing a digital image, comprising:
an image input unit providing an input image as image data;
a pupil image determining unit detecting a plurality of pupil information items from the image data to determine the number of eyes in the input image from the plurality of pupil information items;
a sight-line direction calculating unit determining a plurality of sight-line direction information items respectively corresponding to the respective plurality of pupil information items;
an image recapturing determining unit determining whether recapturing an image is necessary based on the number of eyes and the plurality of sight-line direction information items; and
an image output unit outputting the image data.

2. The apparatus of claim 1, further comprising a memory unit storing the image data.

3. The apparatus of claim 1, wherein the pupil image determining unit includes:
a pupil information detecting unit detecting the plurality of pupil information items from the image data;
an eye number determining unit determining the number of eyes from the plurality of pupil information items;
a user input unit receiving information regarding the number of persons in the group picture from a user; and
a pupil image control unit controlling the pupil information detecting unit so that the plurality of pupil information items is redetected from the image data if the number of detected eyes is not 2N, where N is a natural number equal to or greater than one, and controlling the user input unit so that the number of persons in the group picture is reinput by the user if the number of eyes does not match the number of persons in the group picture.

4. The apparatus of claim 1, further comprising a plurality of light-emitting units providing a plurality of light sources having a predetermined luminance.

5. The apparatus of claim 4, wherein the sight-line direction calculating unit determines the plurality of sight-line direction information items using patterns of reflected light generated by the plurality of light sources provided from the plurality of light-emitting units for respective pupil information items among the plurality of pupil information items.

6. The apparatus of claim 1, wherein the sight-line direction calculating unit compares the plurality of sight-line direction information items with predetermined sight-line direction information to thereby determine whether a degree of matching of sight-line directions is above a predetermined threshold value.

7. The apparatus of claim 1, further comprising a closed-eye determining unit determining whether an eye is closed in the input image, using the plurality of pupil information items.

8. A method of controlling an apparatus for processing a digital image, the method comprising:
providing an input image as image data, using one or more processors;
detecting a plurality of pupil information items from the image data to determine the number of eyes in the input image from the plurality of pupil information items;
determining a plurality of sight-line direction information items respectively corresponding to the respective plurality of pupil information items; and
determining whether recapturing an image is necessary based on the number of eyes and the plurality of sight-line direction information items, thereby retaking the image or outputting the image data.

9. The method of claim 8, further comprising storing the image data.

10. The method of claim 8, wherein the determining of the number of eyes includes:
receiving information regarding the number of persons in the group picture from a user, detecting the plurality of pupil information items from the image data;
determining the number of eyes from the plurality of pupil information items; and
determining whether the number of eyes is 2N or determining whether the number of eyes matches the number of persons in the group picture, where N is a natural number equal to or greater than one; and
detecting again the plurality of pupil information items from the image data if the number of detected eyes is not 2N, and rereceiving information regarding the number of persons in the group picture from the user if the number of eyes does not match the number of persons in the group picture.

11. The method of claim 8, wherein the determining of the plurality of sight-line direction information items includes:
providing a plurality of light sources to the outside having a predetermined luminance;
obtaining patterns of reflected light generated by the plurality of light sources for respective pupil information items among the plurality of pupil information items; and
determining sight-line direction information items according to the patterns of reflected light.

12. The method of claim 11, wherein the determining whether recapturing an image is necessary includes:
comparing the plurality of sight-line direction information items with predetermined sight-line direction information to determine a degree of matching of sight-line directions; and
determining whether the degree of matching of sight-line directions is above a predetermined threshold value.

13. The method of claim 8, further comprising determining whether an eye is closed in the input image, using the plurality of pupil information items.
